(19) United States
(12) Patent Application Publication
(10) Pub. No.: US 2004/0064524 A1
(43) Pub. Date: Apr. 1, 2004

(54) Method and system for efficient dissemination of information

(76) Inventors: Ate Sander Van Steenbergen, Groningen (NL); Cornelis Casparus Van Bijsterveld, Voorschoten (NL); Jan Gerard Snip, Zoeterwoude-Dorp (NL)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/451,283

(22) PCT Filed: Jan. 11, 2002
(86) PCT No.: PCT/EP02/00276

(30) Foreign Application Priority Data
Jan. 12, 2001 (NL) 1017087
Feb. 7, 2001 (NL) 1017301

(51) Int. Cl. G06F 15/16

(52) U.S. Cl. 709/217

(57) ABSTRACT

Method and system for the dissemination of information via a broadcasting system (1, 2) and broadcast terminals (3, 4). An information server (12) is accessible for telecommunication terminals (7) via a telecommunication network (5). A user who hears or sees an interesting primary information block selects it by making a call via his telecommunication terminal (7) to the information server (12). The information server records a selection code and the address of the calling user, and on the basis of the selection code selects a secondary information block and sends it to the user. As selection code a time code can be used, corresponding with the time at which the relevant primary information block was transmitted. If the broadcasting system comprises several broadcast channels etc., the user specifies the particular one by stating a module code or a specific number under which the information server (12) is called up. The address of the user can be derived from the CLI of the telecommunication terminal (7). In addition, the secondary information can be returned directly to that CLI. The invention is interesting as an advanced platform for the marketing of audio and video material and—via advertising blocks—other services and products.

### BACKGROUND

The invention relates to a method for the dissemination of information, wherein information is transmitted by a broadcasting system to a plurality of broadcast terminals. The invention also relates to a system that comprises means for the implementation of the method according to the invention. Such a method and system are generally known as radio or television broadcasting. Auditory and visual information respectively are transmitted in the form of reports, news, music, advertising, etc. by the broadcasting system that comprises studios in which programmes are made and transmitters via which they are broadcast. At the receiver end the transmitted information is received by “users” by means of “broadcast terminals”—radio or TV receivers.

At present, if a user, while listening to or viewing the radio or TV receiver respectively, hears or sees information about which he would like to know more, it is usually quite laborious to get this information. Even if—for example in an advertising block—a telephone number or Internet address (www or e-mail address) is given, it is still a time-consuming and inefficient procedure to obtain the desired information, since it is necessary to note down a telephone number or address and then contact it via a telephone or PC. The need is sometimes also felt to be able to view or listen to information, for example TV pictures of a sports event, again in the future.

### THE INVENTION

Aim

The invention proposes a method and system wherein a listener or viewer, while listening to or viewing information transmitted via the broadcasting system, can rapidly and effectively indicate interest in a particular piece of information—hereafter referred to as “information block”—and wherein this information need can also be satisfied rapidly and effectively. The present method and system are of benefit both to the takers of information—the viewers and listeners—and to the information providers, in this case programme makers, advertising agencies, service and product providers, radio and TV operators, etc.

Information Server

In brief, the invention can be summarised as follows. A listener or viewer, on hearing or seeing an interesting news item, hereafter referred to as “primary information block”, contacts—via his mobile telephone for example—an information server and notifies it that he wishes to receive further information (or a repeat of the information item)—hereafter referred to as “secondary information block. The requested secondary information block is characterised by a selection code, for which there are a number of options. The information server must, moreover, have an address (incl. indication of the transmission medium) to which (and how) the secondary information must be sent. A number of options are available for this as well.

In more detail, the present invention accordingly comprises a method and system for the dissemination of information, wherein information is transmitted by a broadcasting system to a plurality of broadcast terminals, wherein the following steps are performed:

a. a user—who hears or sees by means of his broadcast terminal an interesting primary information block—selects that primary information block by making a call, via a telecommunication terminal and a telecommunication network, to an information server;

b. the information server records a selection code, related to the primary information block, as well as an address of the user;

c. on the basis of the selection code, the information server selects a secondary information block and sends it to the user.

Selection Code

The selection code can be transmitted (manually) by the user to the information server. The user must, however, know a code by which he can specify the programme; the code may, for example, be given in the radio or TV programme. Another option is for there to be a link—for example via infra-red, DECT or “Bluetooth”—between the broadcast terminal (radio or TV receiver) and the telecommunication terminal (telephone), by which the requested selection code can be transmitted (without human intervention) to the telecommunication terminal and on to the information server.

Time Code

If there is no link between the radio or TV receiver and the telephone, it is an option for the information server to record as selection code a time code that is related to the time that the primary information block was transmitted. The information server must then comprise means for—possibly together with the broadcasting system—determining, on the basis of the time code on the one hand and the times known in the broadcasting system or in the information server at which various programme components are transmitted on the other hand, the programme component about which further—secondary—information was requested. An option is for the user to transmit the time code (here the broadcast time) to the information server. The advantage of this is that the user can do this at a later time. A disadvantage is that the user has to remember the broadcast time or note it down and that this time has to be manually entered, which—certainly when using a telephone—is no simple matter. Another option is for the time code to be determined as a function of the time at which the call was made to the information server, either the time at which the telecommunication terminal makes the call to the information server (transmission time, to be recorded by the telephone) or the time at which the information server receives the call from the telecommunication terminal (reception time, to be recorded by the information server). In the latter case, it is sufficient for the user only to make a call to the information server (without further codes), since the time recorded by the information server is an indication of the selected primary information block.

Time Window

Since when using a time code that is derived from the moment at which the call was made to the information server, this time code will always be later than the moment at which the primary information block is transmitted, the information server will, when selecting the requested secondary information block, have to define a time window that is large enough to guarantee that the information in which the user is interested falls within this time window, for example a time window of five minutes. It is then up to the user to select from the received information (about a programme time of—in this case—five minutes) the particular information he requires.

Broadcast Modules

The broadcasting system normally comprises several broadcast modules—transmission channels and transmission stations or broadcast providers, etc.—via which the information is disseminated. If via a particular broadcast module the user hears or sees an interesting primary information block and selects that primary information block by making a call via the telecommunication terminal and the telecommunication network to the information server, the selection code must be supplemented by a module code that corresponds with the broadcast module via which the primary information block was received.

An alternative for the use of a module code is the use of several telephone numbers (in general: network addresses) by which the information server can be called up, whereby the network addresses to be used correspond to the various broadcast modules. The user who, via his broadcast terminal, hears or sees an interesting primary information block via a particular broadcast module, then selects that primary information block by making a call with his telecommunication terminal to the network address of the information server that corresponds with the broadcast module via which he heard or saw the interesting primary information block.

User Address

The requested secondary information must be sent by the information server via a particular medium to a particular address. If necessary or desired, the user specifies in an initial logging-in step an address to the information server to which the secondary information block is to be sent. This offers the possibility for the address to which the secondary information block is to be sent to be derived from an identification code of the telecommunication terminal—for example a “Calling Line Identifier” (CLI)—that is used by the user for calling the information server. If desired, the information server can obtain the address of the user from a special server that comprises a register containing such CLIs and user addresses; such a system is proposed in a previous patent application in the name of KPN.

Incidentally, it is also possible—without the need for an initial log-in—to send the information to the calling terminal, namely via the telecommunication network to the CLI of the calling terminal.

Information Blocks

The secondary information blocks can—as a function of the selection codes or time codes or of the primary information blocks—be stored and kept up to date in a register within the broadcasting system or a register in the information server. This register can also, for example in the form of a distributed database, be distributed over the broadcasting system and the information server, with the broadcasting system and the information server interworking with each other via an IP data network for example. The secondary information blocks can comprise the primary information block or a part thereof. In particular, this is the case when a repeat of a part of the transmitted programme (primary block) is requested, for example a repeat (secondary block) of an important goal in a football match. The secondary information blocks can also comprise information that is additional to the information of the primary information block, for example ordering information for a CD that was heard in part via the radio. The secondary information blocks can also comprise references to one or more further information blocks, for example by the inclusion in the secondary information block of hyperlinks.

### IMPLEMENTATION

The invention will now be described in more detail with reference to a figure and an embodiment.

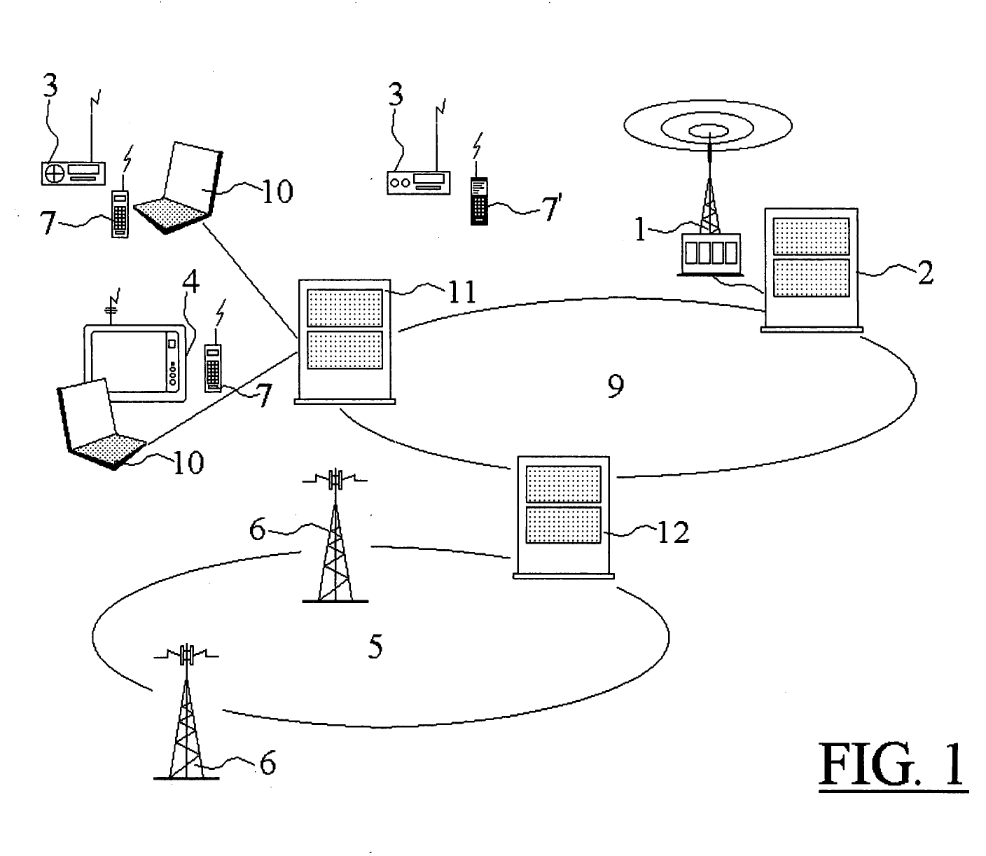

FIG. 1 shows an embodiment of a system according to the invention comprising a broadcasting system 1, including a broadcast server 2, for broadcasting information to a plurality of broadcast terminals, such as radio receivers 3 and television receivers 4. FIG. 1 also shows a (mobile) telecommunication network 5 (with base stations 6) via which telecommunication terminals 7 can communicate with each other. FIG. 1 also shows a (IP) network 9 (Internet) via which terminals 10—via an access server (“Internet Service Provider”) 11—can exchange information with each other and with servers connected to the network 9, such as with an information server 12 connected to the network 9, that via the network 9 interworks with the broadcast server 2. The information server 12 is accessible for the telecommunication terminals 7 via the telecommunication network 5.

The operation is as follows. A user who by means of his broadcast terminal 3 or 4 hears or sees information (“primary information block”) that he (or she) would like to see or hear again or about which he would like to receive further information (“secondary information block”), selects that primary information block by making a call via his telecommunication terminal 7 and the telecommunication network 5 to the information server 12. The information server 12 comprises means for, on receiving the call, recording a selection code related to that primary information block, as well as an address of the calling user. The information server 12 furthermore comprises means for, on the basis of the received selection code, selecting a secondary information block and sending that selected secondary information block to the user. The selection code can be transmitted manually by the user to the information server 12; but the user must then know a code by which to specify the programme, for example a code that is given in the radio or TV programme.

Another option is for there to be a link—via IR, DECT or “Bluetooth”—between the broadcast terminal 3 or 4 and the telecommunication terminal 7 by which the requested selection code can be transmitted (without human intervention) to the telecommunication terminal and then on to the information server. It is to be expected that terminals will be put on the market which will be able to function as broadcast receiver (3, 4) and as telecommunication terminal (7) and as information/data terminal (10). In such a case it would be no problem to link the broadcast receiver part of such a combined terminal to the telecommunication part thereof, and the selection code could be transmitted by the specific setting (reception channel, tuned transmitter, etc.) of the broadcast receiver part (3, 4) sent via the telecommunication part (7) to the information server 12. Moreover, the secondary information requested from the information server 12 can be sent to that same combined terminal, namely to the information/data part (10). If, however, there is no link between the radio or TV receiver and the telephone, it is an option for the information server 12 to record as selection code a time code that is related to the time that the primary information block was transmitted.

In that case, the information server 12 comprises means for—together with the broadcast server 2—determining, on the basis of the received time code on the one hand and the times known in the broadcasting system or in the information server at which various programme components are transmitted on the other hand, the programme component about which further, secondary information was requested. An option is for the user to transmit the time code (here the broadcast time) to the information server. The advantage of this is that the user can do this at a later time. A disadvantage, however, is that the user has to remember the broadcast time or note it down and that this time has to be entered manually, which—certainly when using a telephone—is not easy. Another option is for the time code to be determined as a function of the time at which the call was made to the information server, either the time at which the telecommunication terminal makes the call to the information server (transmission time, to be recorded by the telephone), or the time at which the information server receives the call from the telecommunication terminal (reception time, to be recorded by the information server). In the latter case it is sufficient for the user only to make a call to the information server (without further codes), since the time recorded by the information server is an indication of the selected primary information block. Since when using a time code that is derived from the moment at which the call was made to the information server, that time code will always be later than the moment at which the primary information block was transmitted, the information server will, when selecting the requested secondary information block, have to define a time window that is large enough to guarantee that the information in which the user is interested falls within this time window, for example a time window of five minutes. It is then up to the user to select from the received information (about a programme time of—in this case—five minutes) the particular information he requires.

The broadcasting system 1 disseminates the information to be broadcast via several broadcast modules, by which is meant several channels and several broadcasting organisations. For example, a first channel is used successively by broadcasting organisations A, B and C, a second channel by organisations B, D and E, etc. In order to contact the intended information supplier, the user makes a call to the information server 12, stating a module code that corresponds with the broadcast module via which the primary information block, in which the user was interested, was received. The information server 12 comprises means for recording together with the received call—in addition to the selection code or time code—also the module code, and—on the basis thereof—selecting the secondary information block. In this option the information server 12 is accessed in all cases via the same network address (telephone number). The information supplier is indicated by the module code. Another option is not to use a module code, but to obtain a reference to the relevant information supplier by selecting the information server 12 via several network addresses that are each representative for an information supplier (broadcast modules). The information server 12 comprises means for selecting the secondary information block on the basis of the network address chosen by the user.

The information server 12 comprises means for, in an (initial) logging-in step, recording an address specified by the user to which the secondary information block is to be sent. The information server 12 accordingly comprises means for deriving an identification code—for example the CLI—of the telecommunication terminal from the address to which the secondary information block is to be sent.

Incidentally, it is also possible not to send the requested secondary information (blocks) back to a (separate) information/data terminal 10, but to the telecommunication terminal 7, for example in the form of an SMS (“Short Message System”) message. If the terminal 7 is suitable for reception and reproduction of more advanced (and broadband) information—the terminal 7 is then in fact a combined telecommunication/information terminal (7/10)—for example by application of WAP, I-Mode, etc., the information server 12 can send back all (or most) sorts of secondary information to the terminal 7. In this case, it is a simple matter to make use of the “reply” function of SMS, by which the information is sent back to the source address (the CLI) of the terminal 7 which made the call to the information server 12. When using the “reply” function, it is of course not necessary for the user to specify in an initial logging-in step his (“reply”) address, since the information server 12 can itself find the address to which the information is to be sent. In that case, the secondary information is not sent to the user (namely to his terminal 10) via the network 9, but via the network 5. Information that must come from the Internet 9—from server 2 or other servers connected the Internet—is then routed to the information server 12, which then sends the information via the network 5 to the terminal 7 that requested further, secondary information by making the call to the information server 12.

In order to enable the information server 12 to find the requested secondary information blocks at the primary information blocks indicated by the selection code, etc., the information server 12 or the broadcasting system—in particular the broadcast server 2—or both together, can comprise a register of secondary information blocks related to the various primary information blocks. The secondary information blocks in the register can comprise the relevant primary information blocks—or a part thereof. This is particularly the case if—as part of the selection code—a repeat of the primary information block is requested. The secondary information blocks can furthermore comprise information that is additional to the information of the relevant primary information blocks. The secondary information blocks can comprise references to one or more further information blocks. Use can here be made of one or more (IP-based) hyperlinks.

With reference to the figure, it is pointed out that the secondary information can be sent to the user by post to his postal address (specified in the initial logging-in step), by e-mail to his terminal 10 or—see the terminal 7′ at the top of the figure—to a (mobile) terminal that is suitable both for telecommunication and for data or multimedia, such as WAP and I-mode terminals, etc. Incidentally, it is of course already possible not to send the requested secondary information (blocks) to an information/data-terminal 10, but to the telecommunication terminal 7, for example in the form of an SMS (“Short Message System”) message. If the terminal 7 is suitable for reception and reproduction of more advanced (and broadband) information—the terminal 7 is then in fact a combined telecommunication/information terminal (7/10)—for example by application of WAP, I-Mode, etc., the information server 12 can send back all (or most) sorts of secondary information to the terminal 7. In this case, it is a simple matter to make use of the “reply” function of SMS, by which the information is sent back to the source address (the CLI) of the terminal 7, which made the call to the information server 12.

As secondary information, either a complete Internet page can be sent or just the URL of that page, that via the terminal 10 or WAP terminal 7 can then be requested via the Internet 9 from the information server 12, the broadcast server 2 or from another server. This is particularly the case if the secondary information is only sent in the form of a URL or hyperlink.

The operation will now be illustrated with the aid of a couple of examples.

Let us assume that on Wednesday Jan. 3, 2001 at about 11:45 a user is listening via his radio 3 to the station Classic FM (FM 90.7) and hears a piece of music about which he would like to know more, for example information about the CD containing the track just played. Up to the present, this eminently logical wish can usually only be fulfilled in a very laborious manner. It would be extremely attractive, both for interested listeners and for CD manufacturers and traders if this wish could be satisfied more easily.

Making use of the present invention, the listener—during or after hearing the piece of music (the “primary information block”)—makes a call via his mobile telephone 7 and the network 5 to the information server 12 and thus indicates that he wishes to receive further information, in this case about the CD (the “secondary information block”). The requested secondary information block is characterised by a selection code, in this example a time code that is recorded by the information server 12 itself on the basis of the time at which the information server 12 receives the call from the user, for example 2001.01.03-11:48. Since when using a time code that is derived from the moment at which the call to the information server was made, that time code will always be later than the moment at which the primary information block was transmitted, the information server will, when selecting the requested secondary information block, have to define a time window that is large enough to guarantee that the information in which the user is interested falls within this time window, for example a time window of five minutes. Accordingly, the information server 12 selects a time window of 11:43-11:48 and transmits secondary information during that period. As an example we shall take the five-minute window from “Playlist”, broadcast to the user by Classic FM (NL) on Wednesday 2001.01.03:

Dear listener,

We received your message on 2001.01.03 at 11:48 with the request for further information about the music that “Classic FM” broadcast between 11:43 and 11:48. By clicking the hyperlinks you can request further information via the Internet.

We wish you lots more listening pleasure—Classic FM.

11:40 5:56 Robert Schumann—Arabesque in C major op. 18 —Joop Stokkermans piano—Arcade 99179

11:46 6:45 Gioacchino Rossini—Petite messe solennelle—Kyrie Riccardo Chailly—Orchestra e coro del Teatro Comunale di Bologna—Decca 444 134 2

The user must himself select the information that he wishes. If he heard it at 11:45, it must have been—in this example—Schumann's “Arabesque in C”. As additional information, the message—as shown underscored above—can comprise hyperlinks to further information sources about the several message items, including a hyperlink to an ordering address, for example http://www.nl.bol.com/cec/cstage?eccookie=&ecaction=bolprdi tmview&PrdId=1000004001235475. As well as for “listeners”, such hyperlinks are of course also very interesting for CD distributors such as BOL, AMAZON, BARNESANDNOBLE, etc. While making the call to the information server 12, the user can enter a code (“module code”) in the information server 12 (possibly via a “Voice Response” system) that corresponds with the radio channel, radio station or broadcasting corporation via which the primary information block was received, for example “907” for the station/operator “Classic FM (NL)” (broadcasting on 90.7 MHz.

An alternative for the use of a module code is the use of several telephone numbers by which the information server can be called up and that correspond to the several broadcast modules. In this case the user dials 0900 907 or—via “name dialling”—0900 CLASSICFM, thus calling the information server. On the basis of the dialled number, the information server detects the broadcast module via which the interesting primary information block was received by the user. In the same way, the user can indicate his wish to receive further information about a programme that was transmitted by Radio I, namely by passing on to the information server 12 a module code (for example) “1007” (Radio I transmits on 100.7 MHz) or by (without module code) dialling the information server 12 via a specific telephone number, for example 0900 1007 or 0900 RADIO1. The secondary information requested by the user must be sent by the information server via a particular medium to a particular address. To this end, the user specifies in an initial logging-in step an address to the information server 12 to which the secondary information block is to be sent and how it is to be sent, for example via the Internet 9 to the e-mail address of the user or in the form of an SMS message via the telecommunication network 5 to the terminal 7 of the user. The address to which the secondary information block is to be sent can be derived by the information server 12 from the “Calling Line Identifier” (CLI) of the terminal 7 that is used by the user for calling the information server. If desired, the information server 12 can derive the user's reply address from a (not illustrated) TTP (“Trusted Third Party”) or other address server that comprises a register with CLIs and user addresses.

The secondary information blocks are—as a function of the selection codes or time codes or of the primary information blocks—stored and kept up to date in a register in the broadcast server 2, in the information server 12 or distributed over both. An example of a register with secondary information will now be given. Note, the primary information blocks consist of the broadcast pieces of music, the secondary information blocks consist of the CD information, etc. that are shown below in abbreviated form. More detailed “playlists” can be found in this example elaborated for “Classic FM” under http://www.classicfm.nl/dezeweek. The information recorded there is not provided with ordering information. Such ordering information, consisting of—amongst other things—hyperlinks such as shown above, can for example be located in the information server 12. To this end, the manager of the information server 12 can conclude contracts with CD suppliers such as BOL.com, etc.

Playlist 2001.01.03:

00:01 Carnaval des animaux (14)—Camille Saint-Saëns

00:03 Cent mille chansons—M. Magne/E. Marnay

00:07 Clarinet Concerto in A major KV 622 (3)—Wolfgang Amadeus Mozart

00:15 Holberg suite op. 40 (3)—Edvard Grieg

00:18 Titanic—Distant memories—James Horner

00:21 Violin sonata in A major (4)—César Franck

00:26 Symphony No. 1 in D major “Titan” (2)—Gustav Mahler

00:34 Cantata BWV 156—Johann Sebastian Bach

00:36 Wiegenlied—Johannes Brahms

00:39 Firebird suite—Berceuse—Igor Stravinsky

00:42 The enchanted lake op. 62—Anatole Liadov

00:50 Piano quintet in A major, the “Trout” quintet (2)—Franz Schubert

01:00 Piano Concerto No. 5 in E flat major op. 73 (2 and 3)—Ludwig van Beethoven

01:18 Brandenburg Concerto No. 1 in F major (3)—Johann Sebastian Bach

.

.

.

.

.

.

23:12 Organ Concerto in B flat major op. 4 no. 1 (2)—Georg Friedrich Händel

23:18 A midsummer night's dream op. 61—Entr'acte—Felix Mendelssohn-Bartholdy

23:21 Serenade No. 10 in B flat major KV 361 (3)—Wolfgang Amadeus Mozart

23:26 Rêverie, op.24—Alexander Scriabin

23:30 Lakmé—Flower duet—Lêo Delibes

23:36 Das wohltemperierte Klavier—Prel. and Fugue No. 1—Johann Sebastian Bach

23:39 Rondo a capriccio in G major op. 129—Ludwig van Beethoven

23:45 La vie est belle—André Rieu

23:48 Symphony No. 36 in C major KV 425 “Linzer” (2)—Wolfgang Amadeus Mozart

The secondary information blocks can each comprise the relevant primary information block or a part thereof. For example, in this example a part (“an intro”) of the relevant piece of music (“Arabesque”) could be sent to the user in the form of an MP3 file.

The above example can be simply changed into an example in which the user, when seeing—via his TV receiver 4—interesting information, may wish for more information or a repeat, for example a repeat of an important goal in a football match. In the same way as illustrated above, the user can order further “content” from or via the information server 12 and have it sent to him.

It will be clear that the present invention can be applied in a multitude of ways. For example, it also possible in “advertising blocks” of radio and TV broadcasts for products and services to be recommended, about which listeners and viewers respectively will wish to receive further information. If they call the information server 12 via their telephone 7 during or directly after the advertising block, the information server 12 can determine on the basis of the selection code (here the time code) in which advertising block (and via which radio or TV channel) the caller was interested. Subsequently, the information server 12 collects the further, secondary information about the relevant advertising block (from the broadcast server 2 or another “advertising server”) and sends that further information to the terminal 7, 7′ or 10 of the user. Subsequently, the listener/viewer can select from the received secondary information the material which is interesting for him and possibly—for example via the hyperlinks contained therein—call up further information, for example ordering information.

In this way, the present invention forms an advanced, powerful and efficient platform for marketing all sorts of products and services.

1. Method for the dissemination of information, wherein information is transmitted by a broadcasting system (1, 2) to a plurality of broadcast terminals (3, 4), characterised by the steps:
a. a user selects a primary information block by making a call, via a telecommunication terminal (7) and a telecommunication network (5), to an information server (12);
b. the information server records a selection code, related to the primary information block, as well as an address of the user;
c. on the basis of the selection code, the information server selects a secondary information block and sends it to the user.

2. Method according to claim 1, characterised in that the selection code is transmitted by the user to the information server.

3. Method according to claim 1, characterised in that the information server records as selection code a time code that is related to the time that the primary information block was transmitted.

4. Method according to claim 3, characterised in that the user transmits the time code to the information server.

5. Method according to claim 3, characterised in that the time code is determined as a function of the time the call made to the information server.

6. Method according to claim 5, characterised in that the time code is derived from the time at which the telecommunication terminal (7) makes the call to the information server (12).

7. Method according to claim 5, characterised in that the time code is derived from the time at which the information server (12) receives the call from the telecommunication terminal (7).

8. Method according to claim 1, characterised in that the broadcasting system comprises several broadcast modules via which the information is disseminated, wherein the user who by means of his broadcast terminal, via a particular broadcast module, hears or sees an interesting primary information block, selects that primary information block by making a call via the telecommunication terminal (7) and the telecommunication network (5) to the information server (12), stating a module code that corresponds with the broadcast module via which the primary information block was received.

9. Method according to claim 1, characterised in that the broadcasting system comprises several broadcast modules via which the information is disseminated, and the information server (12) can be called up via several network addresses, said several network addresses corresponding with the several broadcast modules, wherein the user who via his broadcast terminal and via a particular broadcast module hears or sees an interesting primary information block, selects that primary information block by making a call via the telecommunication terminal (7) and the telecommunication network (5) to the information server, addressed to the network address that corresponds with the broadcast module via which the primary information block was received.

10. Method according to claim 8 or 9, characterised in that the several broadcast modules are formed by several transmission channels or broadcasting stations.

11. Method according to claim 8 or 9, characterised in that the several broadcast modules are formed by programme blocks of various broadcasting organisations.

12. Method according to claim 1, characterised in that the address to which the secondary information block is to be sent is derived from an identification code (CLI) of the telecommunication terminal (7) that is used by the user.

13. Method according to claim 1, characterised in that the user specifies in an initial logging-in step an address to the information server (12) to which the secondary information block is to be sent.

14. Method according to claim 1, characterised in that the secondary information block is sent to the telecommunication terminal (7, 7′).

15. Method according to claim 1, characterised in that the secondary information block is sent to an information/data terminal (10, 7′).

16. Method according to claim 1, characterised in that the broadcasting system (1, 2) maintains a register of secondary information blocks.

17. Method according to claim 1, characterised in that the information server (12) maintains a register of secondary information blocks.

18. Method according to claim 1, characterised in that the secondary information block comprises the primary information block or a part thereof.

19. Method according to claim 1, characterised in that the secondary information block comprises information that is additional to the information of the primary information block.

20. Method according to claim 1, characterised in that the secondary information block comprises references to one or more further information blocks.

21. Method according to claim 1, characterised in that the secondary information block comprises one or more hyperlinks.

22. System for the dissemination of information, comprising a broadcasting system (1, 2) for transmitting information to a plurality of broadcast terminals (3, 4), characterised by an information server (12) accessible via a telecommunication network (5), wherein a user who by means of his broadcast terminal (3, 4) hears or sees an interesting primary information block (PIB), selects that primary information block by making a call via a telecommunication terminal (7) and the telecommunication network (5) to the information server (12), said information server comprising means for, on receiving the call, recording a selection code related to that primary information block, as well as an address of the calling user, and furthermore means for selecting a secondary information block on the basis of the received selection code and sending that selected secondary information block to the user.

23. System according to claim 22, characterised by means for recording as a selection code a time code that corresponds with the time at which the call was made from the telecommunication terminal (7) to the information server (12).

24. System according to claim 22, characterised in that the broadcasting system comprises several broadcast modules via which the information is disseminated, wherein the user selects the primary information block by making a call via the telecommunication terminal (7) and the telecommunication network (5) to the information server (12), stating a module code that corresponds with the broadcast module via which the primary information block was received and wherein the information server comprises means for recording the module code with the received call and means for selecting the secondary information block on the basis of the received selection code.

25. System according to claim 22, characterised in that the broadcasting system comprises several broadcast modules via which the information is disseminated and the information server (12) is connected via several network addresses to the telecommunication network (5), said several network addresses corresponding with the several broadcast modules, wherein the user selects the primary information block by making a call via the telecommunication terminal (7) and the telecommunication network to the information server, addressed to the network address that corresponds with the broadcast module via which the primary information block was received and wherein the information server comprises means for selecting the secondary information block on the basis of the network address chosen by the user.

26. System according to claim 22, characterised in that the information server (12) comprises means for deriving, from an identification code (CLI) of the telecommunication terminal (7) used by the user, the address to which the secondary information block is to be sent.

27. System according to claim 22, characterised in that the information server (12) comprises means for recording in an initial logging-in step an address specified by the user to which the secondary information block is to be sent.

28. System according to claim 22, characterised in that the broadcasting system (1, 2) comprises a register of secondary information blocks.

29. System according to claim 22, characterised in that the information server (12) comprises a register of secondary information blocks.

30. System according to claim 22, characterised in that the broadcasting system (1, 2) and the information server (12) comprise a register of secondary information blocks distributed over both the broadcasting system and the information server.

31. System according to claims 28 to 30, characterised in that the secondary information blocks in the register comprise the relevant primary information blocks or a part thereof.

32. System according to claims 28 to 30, characterised in that the secondary information blocks comprise information that is additional to the information of the relevant primary information blocks.

33. System according to claims 28 to 30, characterised in that the secondary information blocks comprise references to one or more further information blocks.
